(19) United States
(12) Patent Application Publication
(10) Pub. No.: US 2020/0188852 A1
(43) Pub. Date: Jun. 18, 2020

(54) PROCESS FOR THE REMOVAL OF MAGNESIUM AND CALCIUM CATIONS FROM NATURAL BRINES USING MEMBRANE ELECTROLYSIS WITH RECOVERY OF CATION HYDROXIDES

(71) Applicants: CONSEJO NACIONAL DE INVESTIGACIONES CIENTÍFICAS Y TÉCNICAS (CONICET), Ciudad Autónoma de Buenos Aires (AR); UNIVERSIDAD NACIONAL DE JUJUY, San Salvador de Jujuy Prov.deJujuy (AR); UNIVERSITEIT GENT, Gent (BE)

(72) Inventors: César DIAZ NIETO, Ciudad Autónoma de Buenos Aires (AR); Noelia Anahí PALACIOS, Ciudad Autónoma de Buenos Aires (AR); Victoria FLEXER, Ciudad Autónoma de Buenos Aires (AR); Korneel RABAEY, Gent (BE)

(21) Appl. No.: 16/719,091

(22) Filed: Dec. 18, 2019

Related U.S. Application Data
(60) Provisional application No. 62/781,452, filed on Dec. 18, 2018.

(51) Int. Cl. B01D 61/48; B01D 61/58; C02F 1/52; C02F 1/469

(52) U.S. Cl. CPC B01D 61/48; C02F 1/4695; C02F 1/52; B01D 61/58

(57) ABSTRACT

A process for the removal of divalent cations, such as calcium and magnesium, from a saline aqueous solution such as a natural brine comprising lithium, using an electrolytic cell comprising at least one anion exchange membrane. The process allows removal of undesired components before lithium recovery, by reducing their concentrations to less than 0.1% of their original concentration in the brine while the lithium concentration remains unchanged.

### BACKGROUND OF THE INVENTION

The present invention relates generally to the field of processes aimed at lithium recovery from brines. More particularly, the present invention relates to the field of processes for lithium recovery from brines that comprise at least one electrolysis stage. Even more particularly, the present invention relates to the field of processes for lithium recovery from brine that comprise at least one electrolysis stage to treat a natural brine and that allow removal of undesired components before lithium recovery.

Lithium has traditionally been used in the production of ceramics, glass materials, fats, lubricants, aluminum alloys and air conditioning equipment, where it is used as a dehumidifier. According to the European Union (EU), lithium exceeds the economic importance threshold and is very close to the supply risk threshold.

In the recent years, lithium demand has rapidly increased due to the lithium-battery industry, especially for electric car batteries, due to its elevated energy density and its high electrochemical potential.

Furthermore, lithium batteries may be used as support for the electrical power grid for the storage of energy produced by energy sources that are renewable but intermittent, such as solar, wind and wave energy.

Thus, lithium demand is expected to skyrocket within the next years, with an estimation that, by the year 2100, 3.6 Mt of lithium will be required to supply batteries for portable electronics and 12.8 Mt for lithium-ion batteries in electrical cars.

Various lithium raw materials can be produced from rock ore, since the highest concentrations of lithium-containing minerals are found in granitic pegmatites, spodumene and petalite, and in lithium-rich brines. The latter are the most important sources of lithium, and most of the world's lithium reserves are in brines.

Yaksic and Tilton (2009) carried out an extensive study and reported that the regular source of lithium available in continental brines is approximately 52.3 million tons of Li⁺ equivalent mainly distributed in Argentina, Bolivia and Chile, frequently referred to as the Lithium triangle, where 23.2 million tons are potentially recoverable.

Each salt pan or “salar” has a different chemical composition and, therefore, the brine processing methods for obtaining lithium salts, usually lithium carbonate or lithium chloride, must be adapted to the compositions of different brines.

Li⁺ concentration in brines varies in the range of 0.01 to 0.2%. It is found in combination with large amounts of NaCl, corresponding to a Na⁺ content of between 4.7 and 11% w/w, and lower amounts of other ions at various concentrations, including K⁺ between 0.2 and 2.4% w/w, B between 0.003 and 0.0071% w/w, Mg²⁺ between 0.003 and 3.09% w/w, Ca²⁺ between 0.002 and 3.9% w/w, and SO₄²⁻ between 0.061 and 50% w/w.

Lithium extraction from salars is currently carried out using the evaporitic method. Essentially, the brines are dumped in large open-air ponds, where the highest percentage of water contained in the brines is evaporated through solar radiation and the wind. Water evaporation results in the concentration of the brines and the consequent fractionated recrystallization of different salts of Na, K and Mg in large, open-air shallow ponds.

Different authors estimate that only between 50% and 70% of the total Li⁺ content present in the native brine can be recovered. The following example illustrates the amount of evaporated water: starting from a brine with a concentration of 700 mg of Li⁺/L and with a recovery percentage of 70%, 0.4 million liters of brine, about 383.5 m³ need to be evaporated to produce one ton of Li₂CO₃. If an extraction plant produces an average of 20,000 tons per year of Li₂CO₃, 7,669,388 m³ of brine water need to be evaporated annually. The value is extremely high, noting that all that evaporated water is produced by a single, average-sized lithium-extraction plant.

In order to obtain a brine concentrated in high purity lithium chloride, all other ions contained in the brine must first be removed, such as Na⁺, K⁺, Ca²⁺, Mg²⁺, B³⁺, Fe³⁺, Sr²⁺, Al³⁺ and traces of other metals such as Rb, Cs, etc., present in the brines. Of all the mentioned contaminants, the most problematic impurity for the current lithium-salt production process is Mg²⁺, since this cation and the Li⁺ cation show very similar chemical properties, such as an almost identical ionic radius. Thus, for example, if Mg²⁺ ions are not quantitatively removed in previous steps, MgCO₃ will co-precipitate with Li₂CO₃. Quantitative separation of Mg²⁺ is therefore necessary to produce high purity lithium salts.

Currently, to avoid future problems with Mg, brines are treated with an alkaline solution of CaO or Ca(OH)₂, which triggers precipitation of Mg(OH)₂. The removal of Mg from the brine using lime is an easy method and it is currently the one most used.

However, the addition of CaO considerably increases the concentration of Ca²⁺, making the brine composition even more complex than the original one. At least one fraction of Ca²⁺ coprecipitates together with Mg(OH)₂ as CaSO₄. The Mg(OH)₂/CaSO₄ precipitate is very difficult to separate, and is currently discarded. This produces large quantities of residues, which, despite being non-toxic, occupy significant volumes when accumulated at the edge of the salar. Even for brines with low Mg²⁺ concentration, this process produces at least 2 tons of residues per ton of Li₂CO₃.

The use of lime also imposes a permanent transport of chemicals to isolated regions, with roads in very bad conditions and sometimes subject to extreme climatic events such as heavy snowfalls. Lime is not a particularly expensive material. However, if at least two of the mining projects currently in pilot or exploration stages in the Argentine North-Western region (NOA) were to take place, lime supply from the NOA region would not be sufficient. The import of lime towards the North from other regions of the country would imply an important increase of the cost of this stage of the process, due to freight.

Finally, when the Mg/Li mass ratio is above 8, effective lithium extraction becomes much more difficult and costly. Lime must be added in such a way to yield an approximately equimolar ratio between Ca²⁺ and Mg²⁺. That is, the higher the Mg²⁺ concentration, the more lime will be required, increasing the overall cost of the process. Likewise, the Mg(OH)₂/CaSO₄ precipitate traps significant amounts of lithium-rich brine. And, the greater the amount of precipitate, the greater the volume of lithium-rich brine that will be lost, making the overall lithium-salt recovery process less and less profitable. Unfortunately, a large majority of the world's brine resources are characterized by a high Mg/Li ratio.

Abdel-Aal and Hussein published three articles in 1993 on the production of a Mg(OH)₂ precipitate by passing an electric current through seawater for the production of hydrogen. The electrolytic cell was a single compartment, i.e. no membrane was used. Seawater contains, on average, a total concentration of dissolved species of approximately 35 g/L, while the concentration of total dissolved species of a brine varies between 180 and 330 g/L, depending on the origin of the brine. Finally, Mg(OH)₂ is according to Abdel-Aal et al. is an undesirable precipitate, i.e. its production was not sought. In fact, one of the main difficulties of the mentioned method to produce hydrogen was this precipitate that accumulated on the cathode surface.

However, it is desirable to quantitatively eliminate the Mg²⁺ present in lithium-rich brines, for further processing of these brines to obtain lithium carbonate (Li₂CO₃), or other high purity lithium salts.

Furthermore, it is also desirable, as a secondary objective, to eliminate Mg²⁺ for its recovery a product having its own added value, and not as a residue: Mg(OH)₂. If the original brine contained high concentrations of Ca²⁺, the proposed method also eliminates these cations quantitatively, precipitating them as a product having its own added value: Ca(OH)₂.

What in Abdel-Aal's work (1993) posed a problem to try to avoid, here constitutes a desirable and sought-after fact. Finally, it is sought to work with an electrolytic cell of two compartments separated by an anion exchange membrane, which allows the migration of anions therethrough.

General electro-membrane processes have been well known for several decades and have been applied to several separation processes in the chemical industry. The application of ion-selective membranes in a process of electrolysis of saturated, pure NaCl to produce chlorine gas and caustic soda is the most important electro-membrane process worldwide. Approximately 15 million tons of Cl₂ are produced every year via membrane electrolysis.

However, this type of process had never been used or reported to obtain Mg or Ca hydroxides.

Zhou et al (2018) used electrodialysis to concentrate Li₂SO₄ solutions from H₂SO₄ treatment of Li minerals. This method is simply used to obtain a more concentrated solution, with the same components as the original solution.

Another approach that has been studied in the works of Ji et al. (2017), Zhang et al. (2017), Jiang et al. (2014) and Bunani et al. (2017) is the possibility of using more advanced membranes, such as membranes selective for monovalent ions that do not allow the passage of higher charge ions, or bipolar membranes aimed at removing the Mg²⁺ ions from the feeding solution.

These works do not seek to recover Mg²⁺ ions as a product with added value. It is desirable to be able to do so.

Ji et al. (2017) used an electrodialysis cell containing cation exchange membranes permeable to monovalent cations to separate Li⁺ from Mg²⁺, from an artificial brine containing LiCl and MgCl₂.

An equivalent method was also proposed by Nie et al. (2017), with slight differences, such as the use of an artificial brine containing Na⁺, K⁺, Ca²⁺, and Mg²⁺. The aim of this method is simply to separate these two cations, without generating products.

The cited works reduce the concentration of Mg²⁺, but not completely, thus maintaining a Li/Mg concentration relation of approximately 7.

The purification of NaCl using electrodialysis with selective ion exchange membrane to monovalent ions has also been proposed by Zhang et al. (2014). In this work, the amount of Ca²⁺ and Mg²⁺ contained in seawater, i.e. 665 and 1.546 mg/L, respectively, against 15.117 mg of Na/L, is a problem, and the authors first remove these ions by chemical precipitation with Na₂CO₃ and NaOH. Despite the title of the work, neither the electric field nor the membrane are used for the elimination of the major fraction of Ca²⁺ and Mg²⁺ ions.

Electrodialysis using bipolar membranes has been proposed to convert Li₂CO₃ to LiOH. This was tested only in an artificial solution containing Ca²⁺, Mg²⁺ y Li⁺, wherein Li⁺ was the most concentrated ion, and before entering the electrolytic cell, Mg²⁺ and Ca²⁺ were removed as carbonates in Jiang et al. (2014). More recently, Bunani et al. (2017) also proposed the use of electrodialysis and bipolar membranes for separating lithium from borates, using an artificial tetraborate lithium solution (Li₂B₄O₇.5H₂O), although the purpose was not to separate Li⁺ from other ions in the concentrated solution, wherein the other ions were found at much lower concentrations.

Although electrolysis with separation by membranes is a known process, it has never applied to the quantitative and total removal of Mg²⁺ and Ca²⁺ ions from natural brines, with the subsequent recovery of Mg(OH)₂ and Ca(OH)₂.

In this context, there is therefore a need to provide new processes for removing Mg²⁺ from brines.

Indeed, it is desirable to provide a process that allows removal of Mg²⁺, reducing its concentration to less than 0.1% of the original concentration, while maintaining the concentration of Li⁺ unchanged. In addition, there is a need for a process that is applicable to salars with different Mg²⁺ and Ca²⁺ concentrations, since Mg²⁺ can be selectively precipitated, postponing the precipitation of Ca²⁺ by controlling the pH of the system.

It is also necessary to provide not only a process for the recovery of high purity Mg(OH)₂, but also for the recovery of other valuable products such H₂, Cl₂, and Ca(OH)₂, if the concentrations of Ca²⁺ in the original brine were perceptible.

### BRIEF DESCRIPTION OF THE INVENTION

Therefore, an object of the present invention is a process for the removal of divalent cations from saline aqueous solutions, wherein the process comprises the steps of:

a) providing a saline aqueous solution comprising initial concentrations of divalent cations in a cathodic compartment of an electrolytic cell comprising at least one anion exchange membrane, wherein the at least one anion exchange membrane separates the cathodic compartment from an anodic compartment of the electrolytic cell;

b) passing a direct current through the electrolytic cell in order to increase the pH of the saline aqueous solution to a pH of about 9 or higher, thereby producing a precipitation of hydroxides of the divalent cations; and

c) separating precipitated hydroxides of the divalent cations as the pH of the saline aqueous solution increases, in order to obtain a treated saline aqueous solution, wherein the treated saline aqueous solution has concentrations of the divalent cations lower than 0.1% of the initial concentrations in the saline aqueous solution.

Preferably, the saline aqueous solution comprising initial concentrations divalent cations is a natural brine containing lithium or other metallic ions intended to be recovered.

More preferably, the divalent cations are selected from the group consisting of magnesium, calcium, other ions that can produce a precipitate under alkaline conditions, and mixtures thereof.

In a preferred embodiment, the pH of the brine is kept between 9 and 10.5 in order to precipitate magnesium hydroxide but not precipitate calcium hydroxide.

In a preferred embodiment, the saline solution is pre-treated to remove boron containing compounds before the electrolysis step. In case the saline aqueous solution comprises boron containing compounds, the solution can be pretreated in order to reduce its boron content, thus facilitating precipitation reactions involving divalent ions. The boron content may be reduced using ion exchange or other techniques known in the art.

In another preferred embodiment, after precipitation of magnesium hydroxide, the pH of the brine is increased to 12 or more, in order to precipitate calcium hydroxide.

In yet another preferred embodiment, the step of passing a direct current through the electrolytic cell in order to increase in the pH of the saline aqueous solution is carried out in a second electrolytic cell. Preferably, the second electrolytic cell is similar to the electrolytic cell.

In a preferred embodiment, the saline aqueous solution comprising initial concentrations of divalent cations is mixed, in a separate vessel, with an alkaline saline aqueous solution obtained from the cathodic compartment of the electrolytic cell, thereby producing the precipitation of hydroxides of the divalent cations.

In another preferred embodiment, the electrolytic cell further comprises a middle compartment and a cation exchange membrane, wherein the anion exchange membrane separates the cathodic compartment from the middle compartment and the cation exchange membrane separates the middle compartment from the anodic compartment of the electrolytic cell. Preferably, the process further includes the step of transferring an effluent from the cathodic compartment to the middle compartment.

In a preferred embodiment, the cathodic compartment is connected to means for separating the precipitated hydroxides of the divalent cations from the saline aqueous solution, such as side crystallizer, a sieve, a filter or combinations thereof.

Preferably, chloride ions migrate from the cathodic compartment towards the anodic compartment through the anion exchange membrane, wherein the chloride ions are oxidized to chlorine gas in the anode.

In a more preferred embodiment, the processes allows removal of Mg²⁺, reducing its concentration to less than 0.1% of the original concentration in the brine, keeping the Li⁺ concentration unchanged and recovering Mg²⁺ as Mg(OH)₂.

In an even more preferred embodiment, the described process allows removal of Ca²⁺, reducing its concentration to less than 0.1% of the original concentration in the brine, keeping the Li⁺ concentration unchanged and recovering Ca²⁺ as Ca(OH)₂.

In addition to Mg(OH)₂ and Ca(OH)₂, H₂ and Cl₂ are also produced, and in cases, recovered by the process of the present invention.

The present invention uses an electric current to achieve an increase in pH thereby eliminating the need to use chemical product, such as CaO.

Furthermore, the provision of electric current is not limited to a specific energy source. The electric current for the process of the present invention may be, for example, obtained from a solar energy source, such as solar panels installed near a salar. It can also be derived from combustion of natural gas.

### BRIEF DESCRIPTION OF THE FIGURES

FIG. 1 shows a schematic representation of a membrane electrolysis cell.

FIG. 2 shows solubility vs temperature curves for NaOH, LiOH, Mg(OH)₂ and Ca(OH)₂, wherein data were obtained from CRC Handbook of Chemistry and Physics, 91th Edition and Solubilities of Inorganic and Organic compounds Vol. 1, part 1 (Pergamon Press). By controlling pH Mg²⁺ can be selectively precipitated as Mg(OH)₂, thus avoiding coprecipitation with Ca(OH)₂.

FIG. 3 shows a graph wherein the long-dashed curve indicates at which pH the precipitation of Mg(OH)₂ begins, depending on the initial concentration of Mg²⁺ in the brine; the short-dashed curve shows the final pH of the solution when precipitating 99.9% of the Mg²⁺ ions originally present in that brine; and the bold solid curve and the fine solid curve indicate, respectively, the corresponding pH for the case of Ca²⁺, i.e. pH at which precipitation begins and pH at which 99.9% of the ions originally present in the original brine have precipitated. These curves were obtained using solubility products.

FIG. 4.a shows a graph depicting time dependence of the pH with electrolysis time for the BI brine (Table 1), for current density=223 A·m⁻², recirculation flow rate=6 L·h⁻¹, and brine volume=1 L.

FIG. 4.b shows a graph depicting the dependence of magnesium (round-dotted curve) and calcium (square-dotted curve) concentrations with pH, under the same experimental conditions as in FIG. 4.a.

FIG. 5 shows brine compositions determined by ICP-OES at different moments: (dotted bars) native brine; (bars with slash lines) after electrolysis until pH=10.5; (bars with double stripes) after electrolysis until pH=13.1. Experiments on BI brine. The graph in the box shows a close-up on Li⁺, Mg²⁺, Ca²⁺ and B concentrations. Current density=223 A·m⁻², recirculation flow rate=6 L·h⁻¹, and total brine volume=1 L were used.

FIG. 6 shows graphically reproducibility of the process through dependence of pH with time for two completely different reactors, using BI brine, current density=223 A·m⁻², recirculation flow rate=6 L·h⁻¹ and total brine volume=1 L.

FIG. 7 shows the evolution of pH over time during electrolysis of three brines of different composition (see Table I), wherein BI (round-dotted curve); BII (square-dotted curve); and BIII (triangular-dotted curve). The same operating conditions were used in all three cases: current density=223 A·m⁻², recirculation flow rate=6 L·h⁻¹, and total brine volume=1 L.

FIG. 8 shows the dependence of the DC source (E_{source}) voltage with current density during the electrolysis process. Data correspond to BI brine, with a recirculation flow rate=6 l·h⁻¹. The slope of the curve shows an internal resistance value of 1.75Ω.

FIG. 9 shows a preferred embodiment of an assembled electrochemical reactor according to the present invention.

FIG. 10 shows the electrochemical reactor of FIG. 9 unassembled, showing its constitutive elements.

FIG. 11 shows a preferred embodiment of an electrolysis unit to carry out the process of the present invention, comprising: the electrochemical reactor of FIG. 9, peristaltic recirculation pumps, direct current source, external reservoir and crystallizer and interconnection hoses.

### DETAILED DESCRIPTION OF THE INVENTION

The invention will now be described in further detailed below, with references to the accompanying figures and examples, which are non-limitative embodiments of the present invention.

An object of the present invention is a membrane electrolysis process used as a method for eliminating Mg²⁺ y Ca²⁺ from brines.

This method combines electromigration through a membrane selective to ions of a certain charge, with crystallization. The process is fast, independent from climatic conditions, and it does not require the constant transport of materials to isolated regions, thus overcoming the inconveniences and disadvantages of similar processes in the prior art.

In addition to offering economic improvement and being environmentally friendly, it is easily adaptable to brines having different concentrations of Mg²⁺.

Further, the proposed method recovers at least three products, therefore vastly compensating the operational costs and minimizing waste production as much as possible.

The products yielded by the process of the present invention comprise chlorine gas (Cl₂), hydrogen gas (H₂), Mg(OH)₂ and Ca(OH)₂, the latter in the case of brines that also contain high amounts of Ca²⁺.

In particular, Mg(OH)₂ can be recovered with a high degree of purity. The EU has recently declared Mg as a critical raw material with great economic importance.

Magnesium improves the mechanical, manufacturing and welding characteristics of Al when used as an alloying agent. These alloys are used in the construction of airplanes and cars. Mg(OH)₂ is added to plastics to make them fire resistant and is used in medicine. MgO is used to make refractory bricks for fireplaces and furnaces. It is also added to livestock feed and fertilizers, to name just a few of its many applications. In some territories, like Argentina, no magnesium salt or oxide is currently being produced.

Membrane electrolysis (ME) is an electrochemical process for the separation of ions through an ion exchange membrane from one solution to another under an electrical potential difference.

In the process of the present invention, the ME cell comprises two electrolytic compartments, the anodic and cathodic compartments, separated by at least an anion exchange membrane (AEM). The AEM facilitates selective mass transport between these two compartments, allowing the passage of anionic species only.

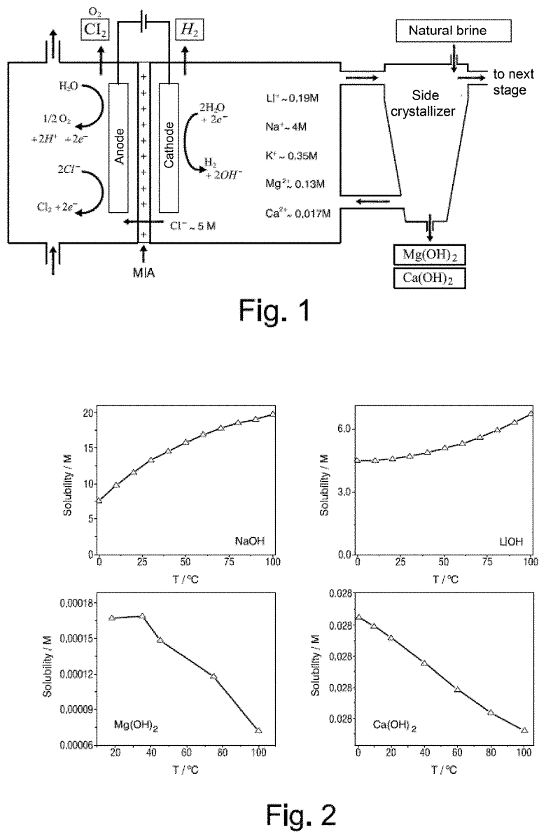

The process is carried out at constant current density and by applying direct current. The need to maintain electroneutrality in both compartments will force the selective movement of the anions from the cathodic compartment to the anode compartment. The process is shown schematically in FIG. 1.

In the anodic compartment, oxidation of water can occur, generating oxygen (equation 1) or oxidation of chloride to chlorine (equation 2). Whether the reaction is 1 or 2, there will be an excess of positive charges per generation of H⁺ or consumption of Cl⁻.

H₂O→½O₂+2H⁺+2e⁻ (1)

2Cl⁻→Cl₂+2e⁻ (2)

Reaction (2) is preferred over reaction (1) due to the value and usefulness of chlorine as a product. Chlorine gas can also be easily converted into hypochlorite (NaOCl) or hydrochloric acid (HCl).

Meanwhile, water reduction occurs in the cathodic compartment, generating hydrogen gas and hydroxide ions (reaction 3), and a net increase in negative charges.

2H₂O+2e⁻→2OH⁻+H₂ (3)

The need to maintain electroneutrality in both compartments will force the transport of charges through the membrane. Since the membrane does not allow cations to pass through, the excess anions present in the cathodic compartment will move selectively from the cathodic compartment to the anodic compartment.

The anodic compartment contains a titanium oxide electrode coated with iridium oxide and a 0.1 mol/L anodic solution of NaCl, 0.1 mol/L of KNO₃ or 0.5 mol/L of sodium carbonate/bicarbonate buffer, which is recirculated.

This cathodic compartment comprises a stainless-steel electrode and is fed with natural brine.

As a large quantity of hydroxide ions are generated, Mg(OH)₂ can precipitate, since it is almost insoluble in water, unlike NaOH and LiOH which have high solubility values (see FIG. 2). In addition, temperature variation does not significantly affect the enormous difference in solubility between these three hydroxides.

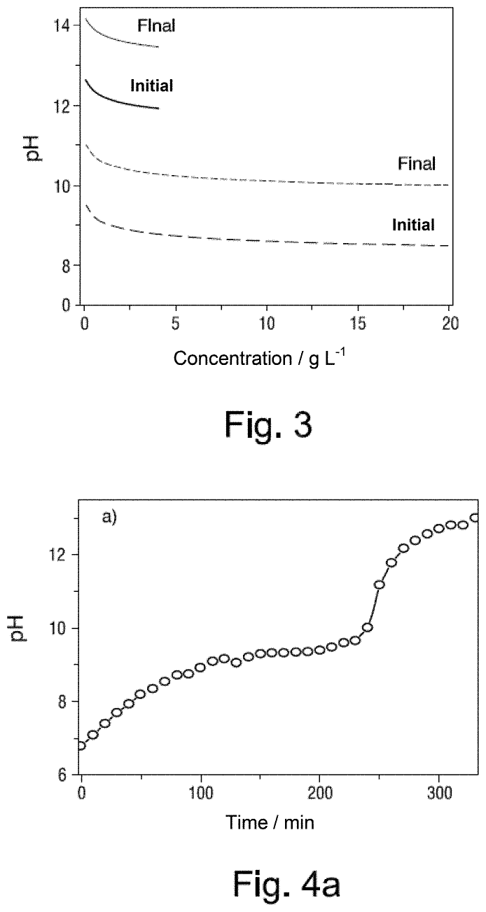

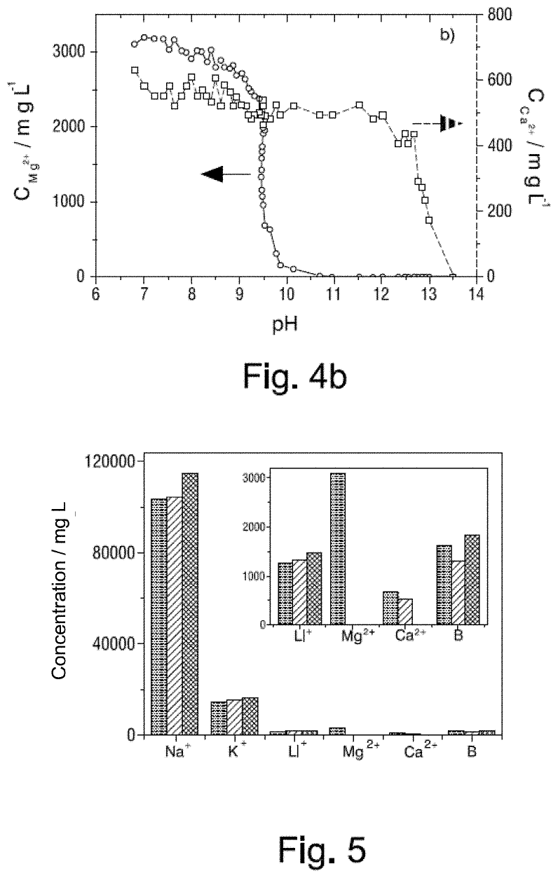

Assuming a brine with a concentration of 6.50 g/L Mg²⁺ and 0.5 g/L Ca²⁺, Mg(OH)₂ starts precipitating at pH=8.73. At pH=10.5, 99.9% of the Mg²⁺ originally present in the brine is precipitated. Furthermore, in order for Ca(OH)₂ to start precipitating, a pH of 12.5 is required. Although these numbers correspond to theoretical calculations based on solubility constants, the experimental data confirms the calculations (see FIGS. 3 and 4). As can be seen in reaction 3, the amount of hydroxide ions generated depends on the amount of charge that circulated in a certain circulation time and at a certain value of the current. The advantage of the proposed method is that it is possible to control the total circulating charge value, thus being able to control the pH of the solution.

The increase in pH can be alternatively carried out in one single or in two identical electrochemical reactors. In this second case, when the saline solution reaches a pH of approximately 10.5 in the first reactor, it is passed on to a second reactor wherein the electrolytic treatment of the saline solution is followed up to pH values of the order of 12.5. It may be convenient to put this into practice in such way to avoid cross-contamination, facilitating the recovery of two different hydroxides separately as, for example, in the case of a natural brine when separating Mg(OH)₂ and Ca(OH)₂.

Both the precipitated Mg(OH)₂ and Ca(OH)₂ are decanted and separated from the solution through a filter. In this way, a treated saline solution is obtained, in which the amounts of Li⁺, Na⁺, K⁺ originally present and all other cations remain unchanged. On the contrary, the concentrations of the divalent ions, such as Mg²⁺ and Ca²⁺, are decreased to values of 0.1% or less than those originally present. Unexpectedly, this decrease is achieved without the need to increase the concentration of any other chemical species.

All the tests of the proposed methodology were carried out with natural brines obtained in the Argentine Puna.

The electrochemical reactors and experimental methods and conditions will be described in further detail below, with references to the accompanying figures.

The electrochemical reactor (1) used was made entirely of acrylic. Two acrylic frames (2, 2′) with internal dimensions of (5×20×2) cm delimit the anodic (3) and cathodic (4) compartments, respectively. The two compartments (3, 4) are separated by a commercial anion exchange membrane (5) (AEM, AMI-7001CR, Membrane International Inc., USA). Two solid acrylic plates (6, 6′) close the compartments (3, 4). Between the different portions of the reactor (1) a 1 mm thickness commercial rubber frame or elastic gasket is placed (7, 7′, 7″, 7′″, 7″″) to avoid fluid loss. The different portions of the reactor (1) are assembled using metal rods (8), nuts (9) and washers (10) that are tightly adjusted to hold the different parts of the reactor body together (1). The metal components (8, 9, 10) do not engage with the fluid phases.

Both compartments (3, 4) have a fluid inlet at the bottom and an outlet at the top. Each compartment (3, 4) is connected by rubber hoses (11) to a corresponding external reservoir and crystallizer (12, 13), each of which is, respectively, a 1 liter Schott type bottle (12) for the anodic compartment (3) and a decantation cone or crystallizer (13) of plastic material for the cathodic compartment (4). Two peristaltic pumps (14, 14′) constantly circulate the fluids in each of the compartments (3, 4) and the external reservoir and crystallizer (12, 13) through forced convection and, in addition, the pumps allow the circulation of a greater volume of anolite/catolite or brine than that which each compartment (3, 4) can contain. It is a batch system, with forced convection.

Both in the cathodic (4) and the anodic (3) compartments, a total volume of 1 liter of solution is used, wherein this volume includes the solution in the reactor (1), plus the connecting hoses (11), plus the corresponding external reservoir and crystallizer (12, 13).

As anode (15), a commercial titanium electrode in the form of a mesh, covered with a IrO₂/TiO₂ mixed oxide; 65/35%, with dimensions of (4.8×19.8) cm, and 1 mm thickness (Magneto Special Anodes, The Netherlands) was used, with a current collector (16) perpendicular in the center thereof. As cathode (17) a commercial stainless-steel mesh, with dimensions of (4.9×19.9) cm was used, and a current collector (18) in the upper part, composed by an extension of the same steel mesh.

Both the anode (15) and the cathode (17) are physically separated from the anion exchange membrane (5) by a fine plastic mesh (19, 19′) or a net. Thus, the anode (15) and the cathode (17) are approximately 3 mm apart, separated by the two plastic meshes (19, 19′) and the membrane (5).

In a preferred embodiment, the electrolytic cell (1) consists of the following elements, listed from the cathodic (4) to the anodic (3) compartment, in that order: solid acrylic plate (6) which closes the cathodic compartment (4); rubber gasket (7) to prevent leaks; acrylic frame (2) which constitutes the side edges of the cathodic compartment (4); rubber gasket (7′) to prevent leakage; cathode (17) consisting of an electrode in the form of a stainless steel mesh; plastic mesh (19) to prevent physical contact between the cathode (17) and the exchange membrane (5); rubber gasket (7″) to prevent leaks; anionic exchange membrane (5); rubber gasket (7′″) to prevent leaks; plastic mesh (19′) to prevent physical contact between anode (15) and exchange membrane (5); acrylic frame (2′) which constitutes the side edges of the anodic compartment (3); rubber gasket (7″″) to prevent leaks; anode (15) consisting of an electrode in the form of a coated titanium mesh; and solid acrylic plate (6′) that closes the anodic compartment (3).

Alternatively, the electrochemical reactor may consist of three compartments, a cathodic compartment, an anodic compartment and a middle compartment arranged between them, wherein the cathodic and anodic compartments are separated from the middle compartment by means of anion and cathode exchange membranes, respectively.

Thus, by providing at least a cation exchange membrane, the existence of a middle compartment involving the use of more than one membrane is implied. The anion exchange membrane is used in all possible reactor configurations.

The electrochemical process of the present invention can be carried out in more than one electrochemical reactor.

The experiments were conducted exclusively in direct and constant current mode, using a commercial current source (20) (DC, CC, V&A instrument, China). The reported current values refer to the geometric area of the membrane (5) in contact with the solutions which is in the order of 100 cm².

The cell voltage is read directly from the display of the current source (20). The experiments were carried out at room temperature, controlled by air conditioning in the laboratory enclosure regulated to (22±3) ° C.

Natural brine without any prior treatment is added in the cathodic compartment (4). The following options were used for the anodic compartment (3):

a 0.1 mol/L NaCl solution;

a 0.1 mol/L KNO₃ solution; or,

a 0.5 mol/L sodium carbonate/bicarbonate buffer solution.

The experiments were conducted on two natural brine samples taken directly from different locations of Hombre Muerto Salar, located in Catamarca, Argentina. The compositions of these brines are shown in Table 1 below. A third semi-artificial sample was also used, which was obtained by adding 47.3265 g/L MgCl₂.6H₂O (Biopack, p.a.) to the BI brine to simulate a brine with a higher Mg²⁺ composition.

Although in natural brines of the type of the Puna, it is only relevant to precipitate Mg and Ca, in water produced from the oil industry there is also Ba²⁺, for example. It is feasible to precipitate it applying the process described herein. For this reason, the process is applicable, besides to natural brines such as those of the Puna, to water produced from the oil industry and to thermal waters, in which the separation of divalent cations is necessary.

TABLE 1
Composition (mg · L⁻¹) determined analytically by Inductively Coupled Plasma - Optical
Emission Spectrometry (ICP-OES) from the different brines used in the experiments.
Cl⁻ y SO₄²⁻ were determined by ion chromatography.

| | | | | | | | | | Mg/Li | | |
|---|---|---|---|---|---|---|---|---|---|---|---|
| Brine | Li | Ca | Mg | B | Na | K | Sr | Fe | ratio | Cl⁻ | SO₄²⁻ |
| BI | 1.268 | 685 | 3.090 | 1.619 | 103.239 | 14.209 | 79 | 1.3 | 2.4 | 182.850 | 11.155 |
| BII | 589 | 2.109 | 2.687 | 518 | 63.522 | 7.973 | 97 | 26 | 4.6 | ND | ND |
| BIII | 1.268 | 685 | 8.748 | 1.619 | 103.239 | 14.209 | 79 | 1.3 | 6.9 | 199.356 | 11.155 |

ND = not determined.

The compositions of Mg²⁺ and Ca²⁺ in FIG. 4.b were determined by complexometric titration with EDTA (Anedra, p.a.), using Black Eriochrome T (Anedra, p.a.) and Murexide (Anedra, p.a.) as colorimetric endpoint indicators.

All other cation compositions, including Mg²⁺ and Ca²⁺, from the other Figures and Tables were determined by Inductively Coupled Plasma-Optical Emission Spectrometry (ICP-OES).

The pH was registered with a pH meter (Hanna), and with colorimetric pH test paper strips.

The concentrations of and SO₄²⁻ were determined using a DIONEX AS9-HC column in a DIONEX DX-100 ion chromatograph.

The electrochemical reactor described above was assembled and a constant current source was connected so that the stainless-steel electrode is the negative electrode, i.e. the cathode.

The production of gas bubbles is visually and unequivocally detected on both electrodes.

In order to check the identity of the H₂, the decantation cone is temporarily covered, gas is allowed to accumulate for 3 minutes, and a flame is placed close to the cone where the gas accumulated. The sound of a small explosion is heard, which confirms the presence of H₂.

When the KNO₃ solution is used in the anodic compartment, the production of Cl₂ is clearly detected by its irritating odor. Likewise, when a blue litmus paper moistened with water is placed closer to the exit of the compartment, it first turns red and then white, this being a simple reaction to detect Cl₂.

Since Cl₂ is an irritant, once the ability to generate it had been verified, its production was avoided for reasons related to laboratory safety. The experiments mainly serve to test the capacity of the proposed method to remove Mg²⁺ and Ca²⁺ from the brines. Therefore, for most experiments, working with a carbonate/bicarbonate buffer of pH=10 in the anodic compartment was preferred. At this pH, the preponderant oxidation reaction will be (1), whereas if reaction (2) proceeds to some extent, Cl₂ dismutates to Cl⁻ and ClO⁻.

For the purposes of the invention, it is important to determine what happens in the cathode compartment.

Experiments were performed recirculating the brine between the compartment of the electrochemical reactor and the side crystallizer with a constant recirculation flow rate of 6 L·h⁻¹, and applying a constant current of 2.23 A, i.e. membrane 223 A·m⁻². While carrying out the experiment, pH is measured in the side crystallizer. FIG. 4.a is a graph of pH as a function of time in the side crystallizer.

At this pH, the predominant oxidation reaction will be (1), whereas if reaction (2) proceeds to some extent, Cl₂ dismutates to Cl⁻ and ClO⁻.

Likewise, aliquots of the circulated brine were taken in the cathodic compartment, and titrations were carried out on these aliquots to quantify the remaining concentration of Mg²⁺ and Ca²⁺. The graph of these concentrations as a function of pH is shown in FIG. 4.b.

Due to the production of OH⁻, the pH increases in the cathode compartment. From the beginning of the electrolysis, the formation of a fine white precipitate is observed. It is visually detected that the amount of precipitate increases as electrolysis time advances. The joint analysis of FIGS. 4.a) and 4.b) indicates that the precipitate formed is Mg(OH)₂, which in turn is in accordance with the relative concentrations of Mg²⁺ y Ca²⁺ in the original brine, as well as with the solubility product constants of the two hydroxides, that is: pK_{ps,Mg(OH)}_{₂}=11.2 and pK_{ps,Ca(OH)}_{₂}=5 at 25° C.

Mg_{(aq)}²⁺+2OH_{(aq)}⁻→Mg(OH)₂ (3)

Ca_{(aq)}²⁺+2OH_{(aq)}⁻→Ca(OH)₂ (4)

FIG. 4.b shows that for pH<9, Mg²⁺ concentration decreases very slowly, while between pH 9 and 10 there is a drastic decrease in Mg²⁺ concentration. At pH=10.5, Mg²⁺ is no longer detected by either complexometric titration or by ICP-OES, the ICP-OES detection limit for Mg²⁺ being 0.05 mg·L⁻¹. Furthermore, Ca²⁺ concentration in the brine remains approximately constant until pH=12. When pH reaches 13.1, Ca²⁺ is no longer detected either by complexometric titration or by ICP-OES, the ICP-OES detection limit for Ca²⁺ being 0.05 mg·L⁻¹.

FIG. 5 compares the concentrations of the native brine (dotted bars), with the concentrations after performing electrolysis for 235 minutes up to pH=10.5, (bars with slash lines), and after performing electrolysis for 305 minutes up to pH=13.1 (bars with double stripes).

FIG. 5 shows how the concentrations of both Mg²⁺ and Ca²⁺ are depleted after electrolysis. Further, the concentrations of the other elements appear to have increased. This phenomenon is due to a small portion of water being electrolyzed (reaction 3), and anions passing through the membrane towards the anode dragging a hydration sphere.

As used herein, “repeatability” is a measure of the variation in experimental results using a single measuring instrument and/or performed by a single operator. “Reproducibility” is a measure of variability in an assay when replicated entirely from scratch.

Repeatability was determined by measuring the compositions for Mg²⁺, Ca²⁺, Na⁺, K⁺, B, and Li⁺ after electrolysis, replicating the assay four times, using the same reactor, electrodes and membrane. A Variation Coefficient % (VC %) of 5% was determined.

Two tests were carried out on two completely different electrochemical cells built with different frames, electrodes and membranes. For both tests, BI brine was used, a current density=223 A·m⁻², a recirculation flow rate=6 L·h⁻¹ and a total brine volume=1 L.

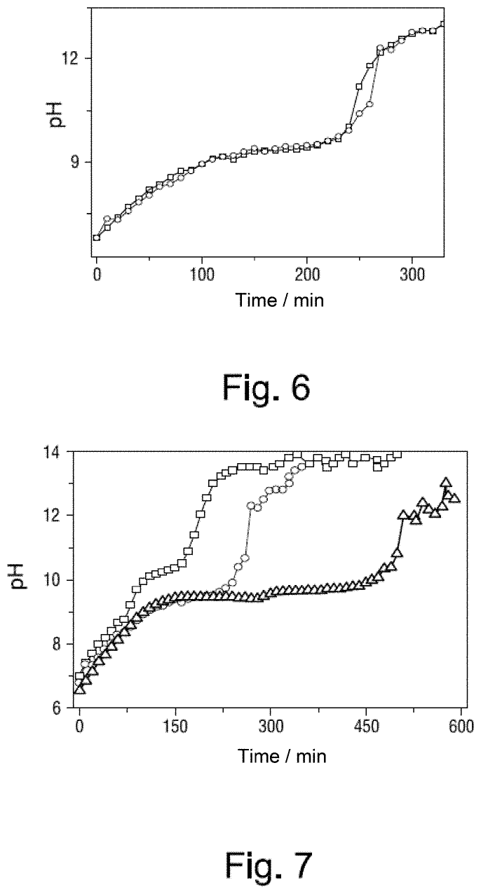

FIG. 6 shows that the experimental curves of pH vs time corresponding to both tests, wherein the curve with square symbols corresponds to reactor 1 and the curve with round symbols corresponds to reactor 2, display very similar results, thereby proving the reproducibility of the process. In this case, a VC % coefficient of 6% was determined.

The values of the coefficients for repeatability and reproducibility indicate the strength of the proposed method for the process of the present invention.

Efficiency in the use of electrical current (%) is calculated using equation (6):

$$η = 100 \times \frac{\{ 2 ( {C}_{0} - {C}_{t} ) + {[ {OH}^{-} ]}_{t} \} \cdot V \cdot F}{i \cdot t} \qquad ( 6 )$$

wherein:
Cₜ and C₀ are Mg²⁺+Ca²⁺ concentrations in the brine for t and 0 times, respectively in mol/L;
[OH⁻]ₜ is the concentration of OH⁻ in the brine at tin mol/L;
V is the total electrolyzed brine volume in L;
F is Faraday's constant in C/mol;
i is the value of constant current applied in A;
t is the total electrolysis time for which efficiency is to be calculated in s.

The electrolysis proceeded until an experimental value of pH=13.1 was reached, measured with pH-meter and confirmed with universal pH paper strip. Considering this value, η=97.99%.

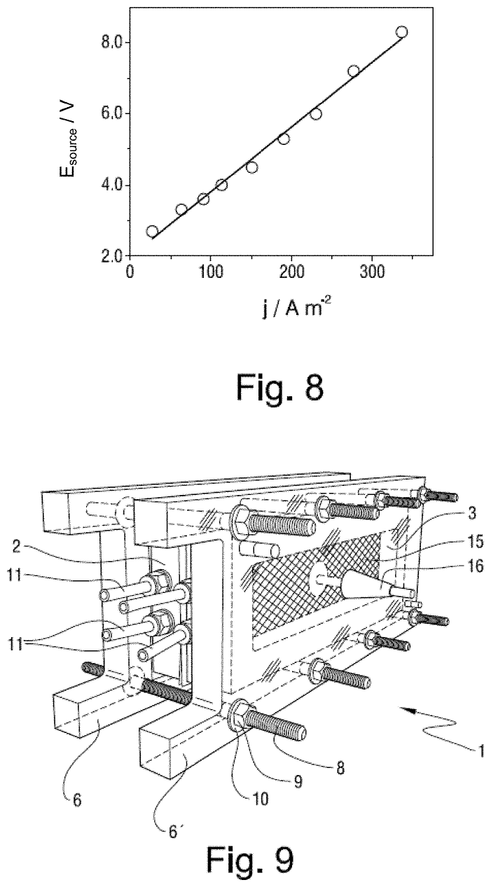

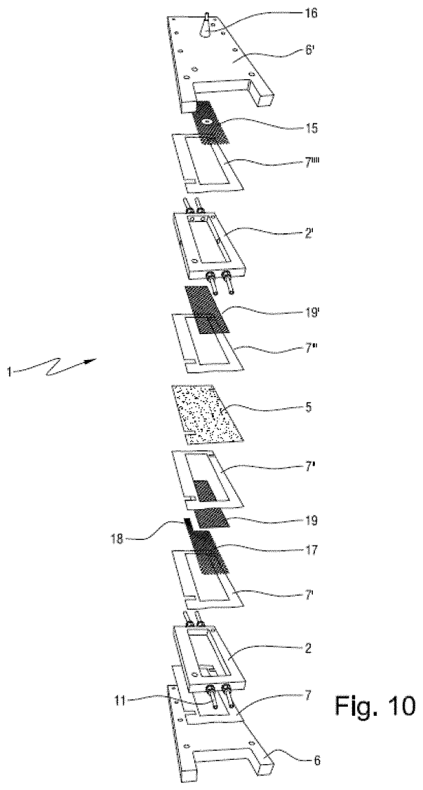

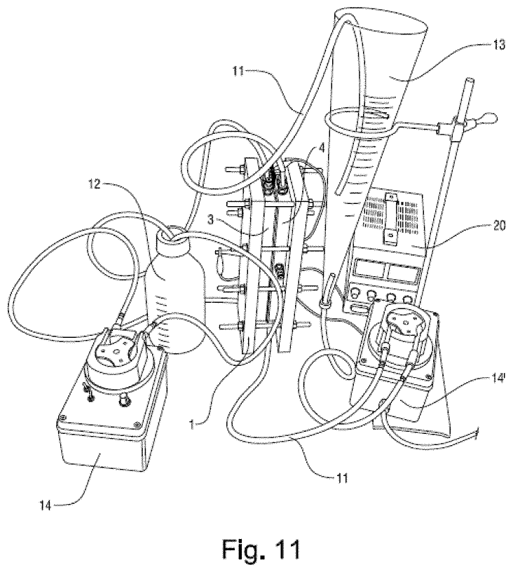

FIG. 8 shows the dependence between DC voltage (E_{source}) and applied constant current density. A linear dependence of the voltage on the current is observed. The value of the E/j slope indicates an internal resistance of the system of 1.75Ω. For each of the experiments carried out to construct FIG. 8, the applied constant current density remains constant. However, no variations greater than 10% on E_{source} are observed. Therefore, this constant voltage can be considered for calculating the process energy consumption.

Energy consumption depends on the brine chemical composition and the working current. Energy consumption per liter of brine (W·h·L⁻¹) is calculated using equation (7):

$$E = {\int }_{0}^{t} \frac{{E}_{source} idt}{V} \qquad ( 7 )$$

wherein:

E_{source} is the current source voltage in V;

i is the applied current in A;

V is the volume of treated brine in L; and

t is the total electrolysis time in s.

For the IV brine and a 223 A·m⁻² current, there is an energy consumption of 62.3 Wh·L⁻¹ (62.3 kW·h·m⁻³). For the same brine and a 27 A·m⁻² current, energy consumption will be 30.6 W·h·L⁻¹ (30.6 kW·h·m⁻³).

### Example 1

One liter of BI brine of Table T above is provided in the cathodic compartment of an electrolytic reactor and one liter of a 0.1 mol/L NaCl solution is provided in the anodic compartment. Solutions from both compartments are constantly recirculated at a flow rate of 6 L·h⁻¹. Using a direct current source, a current density of 223 A·m⁻² is passed for 1 hour 30 minutes at 22° C. In the cathodic compartment, the presence of hydrogen is determined by a flame test. In the anodic compartment, the presence of chlorine is determined by the wet litmus paper test. A whitish precipitate appears in the side crystallizer of the cathodic compartment within 3 minutes of starting the electrolysis. It is visually observed that the amount of precipitate in the side crystallizer increases with the electrolysis time. The aim of this assay was to identify the gases produced in anode and cathode.

### Example 2

One liter of BI brine of Table I above is provided in the cathodic compartment of an electrolytic reactor and one liter of a 0.1 mol/L KNO₃ solution is provided in the anodic compartment. Solutions from both compartments are constantly recirculated at a flow rate of 6 L·h⁻¹. Using a direct current source, a current density of 223 A·m⁻² is passed for 1 hour 30 minutes at 22° C. In the cathodic compartment, the presence of hydrogen is determined by a flame test. In the anodic compartment, the presence of hydrogen is determined by a flame test. A whitish precipitate appears in the side crystallizer of the cathodic compartment within 3 minutes of starting the electrolysis. It is visually observed that the amount of precipitate in the side crystallizer increases with the electrolysis time. The aim of this assay was to identify the gases produced in anode and cathode.

### Example 3

One liter of BI brine of Table I above is provided in the cathodic compartment of an electrolytic reactor and one liter of a 0.5 mol/L sodium carbonate/bicarbonate buffer solution, pH=10, in the anodic compartment. Solutions from both compartments are constantly recirculated at a flow rate of 6 L·h⁻¹. A current density of 223 A·m⁻² is passed at 22° C. pH is measured constantly in the side crystallizer, and when a pH=10.5 is reached the electrolysis is interrupted. The electrolysis time to reach that pH value is 233 minutes. The brine solution is centrifuged for 20 minutes at 3,500 rpm. 30 grams of solid and 0.95 L of BI brine are recovered. This remaining brine tested negative for Mg²⁺, both by ICP-OES and by complexometric titration.

The cathodic compartment of the electrochemical reactor is rinsed, and the 0.95 L of remaining BI brine, from which Mg²⁺ has already been extracted, are reintroduced into the reactor. Electrolysis is continued with the same recirculation flows, current and temperature values. pH measurement is continued in the side crystallizer. After 72 minutes of this new electrolysis stage, the pH reaches a value of 13.1. The brine solution is centrifuged for 20 minutes at 3,500 rpm. 1.7 grams of solid and 0.93 L of BI brine are recovered. This remaining brine tested negative for Mg²⁺ and Ca²⁺, both by TCP-OES and by complexometric titration.

Furthermore, different recirculation flows, current densities and temperatures have been tested, resulting in expected results obtained in more or less time, which is consistent with the nature of an electrolysis process.

### Example 4

In order to test the efficiency of the proposed method on brines of different concentrations, studies were carried out with brines of two other compositions: BII and BIII in Table 1 above. Examples 1 to 3 were repeated with these other two brines.

FIG. 7 shows the pH vs time profiles for the three brines. The profiles have the same general shape as FIG. 4.a obtained for the BI brine. The similar shape of the profiles is attributed to the fact that the chemical processes that originate them are the same. The dissimilar duration of each of the regions in the profile is attributed to the different Mg²⁺ and Ca²⁺ concentrations in each of the brines. The concentrations of these two species will determine how many OH⁻ ions it is necessary to generate electrochemically to precipitate Mg(OH)₂ and Ca(OH)₂. The amount of OH− is proportional to the total current circulating.

1. A process for the removal of divalent cations from saline aqueous solutions, wherein the process comprises the steps of:
a) providing a saline aqueous solution comprising initial concentrations of divalent cations in a cathodic compartment of an electrolytic cell comprising at least one anion exchange membrane, wherein the at least one anion exchange membrane separates the cathodic compartment from an anodic compartment of the electrolytic cell;
b) passing a direct current through the electrolytic cell in order to increase the pH of the saline aqueous solution to a pH of 9 or higher, thereby producing a precipitation of hydroxides of the divalent cations; and
c) separating precipitated hydroxides of the divalent cations as the pH of the saline aqueous solution increases, in order to obtain a treated saline aqueous solution, wherein the treated saline aqueous solution has concentrations of the divalent cations lower than 0.1% of the initial concentrations in the saline aqueous solution.

2. The process of claim 1, wherein the saline aqueous solution comprising initial concentrations of divalent cations is a natural brine containing lithium or other metallic ions intended to be recovered.

3. The process of claim 1, wherein the divalent cations are selected from the group consisting of magnesium, calcium, other ions that can produce a precipitate under alkaline conditions, and mixtures thereof.

4. The process of claim 1, wherein in step b) the direct current is passed at a density of 223 A·m⁻² and at a temperature of 22° C.

5. The process of claim 1, wherein in step b) the pH of the brine is kept between 9 and 10.5 in order to precipitate magnesium hydroxide but not precipitate calcium hydroxide.

6. The process of claim 1, wherein in step b), after precipitation of magnesium hydroxide, the pH of the brine is increased to 12 or more, in order to precipitate calcium hydroxide.

7. The process of claim 1, wherein the electrolytic cell further comprises a middle compartment and a cation exchange membrane, wherein the anion exchange membrane separates the cathodic compartment from the middle compartment and the cation exchange membrane separates the middle compartment from the anodic compartment of the electrolytic cell.

8. The process of claim 7, wherein the process further includes the step of transferring an effluent from the cathodic compartment to the middle compartment.

9. The process of claim 1, wherein the cathodic compartment is connected to means for separating the precipitated hydroxides of the divalent cations from the saline aqueous solution.

10. The process of claim 9, wherein the means for separating the precipitated hydroxides are selected from the group consisting of a side crystallizer, a sieve, a filter or combinations thereof.
